(19) United States
(12) Patent Application Publication
(10) Pub. No.: US 2017/0229036 A1
(43) Pub. Date: Aug. 10, 2017

(54) Apparatus and Method for a Therapeutic and Educational Exercise for Brain Development and Rehabilitation

(71) Applicant: Maria Simeone, Foothill Ranch, CA (US)

(72) Inventor: Maria Simeone, Foothill Ranch, CA (US)

(21) Appl. No.: 14/696,301

(22) Filed: Apr. 24, 2015

(51) Int. Cl. G09B 19/00; G09B 5/04; G09B 19/04; G09B 5/06

(52) U.S. Cl. CPC G09B 19/003; G09B 5/06; G09B 5/04; G09B 19/04; G09B 19/00

(57) ABSTRACT

The invention relates to a means for targeting and stimulating specific areas of neurodevelopment in the brain. The invention provides a series of three types of cues that enable a user to learn and subsequently perform specific bodily movements and unassisted sounds that are precisely paired to promote growth in certain targeted areas of the brain. The present invention further provides a method of using these cues in order to increase total brain development and function in its user.

### BACKGROUND

Field of the Technology

The present invention relates to the field of educational training for specific cognitive growth and development. Publication Classification: CPC 434/236 (Education/Psychology).

Description of the Prior Art

Locomotor activity begins late in the embryonic stage. Fetal movement begins as self-generated nerve impulses that originate in the spinal cord and progresses into voluntary and reflexive movements as the fetus ages. While in the womb and during the first year of life, a baby typically will continue to undergo these neurodevelopmental reflex patterns. These movements have a distinct order and sequence that help wire the central nervous system (CNS) and prime the brain for life-long learning by creating new synaptic connections in the brain which continue well into adulthood. However, brain development is not just limited to in utero, and reflexive wiring and synaptic growth continues well after a child is born.

One fundamental idea of early brain development is that these reflexive movements are accompanied by natural vocalization of the infant, both in utero by taking in sounds of the mother and post-birth. Prior scientific research has also indicated that infants in utero will immediately and specifically respond to the sounds of its mother's voice. Newborn reflexes were found to synchronize perfectly with this prosodic speech. Doctors continually encourage parents to speak to their infants while in utero because the infant's response to such stimulation has been linked to increased fetal brain growth and development. These vocal reflexes support and enhance the benefits of the neurodevelopment reflex patterns by providing additional stimulation to the brain; additionally, there is evidence that “muscle memory” of movement to speech synchronization that is established in infancy can carry on into adulthood.

The use of specific reflexive patterns or movements can be instrumental in stimulating specific regions of the brain. For example, drumming on the body synchronizes the body's natural rhythm and can create a rhythmic connection to one's environment and others. This is necessary for the foundation of healthy brain function, supporting the function of the brain stem, cerebellum, and limbic system. When paired with specific vocalizations, which can tune-in a brain to specific rhythms, the benefit of performing movements that strengthen various brain connections increases as the body tunes its concentration to the act being performed.

In an educational setting, the incorporation of vocals has been found to have a number of positive benefits for brain development. The use of one's own voice allows for a better opportunity to “tune-in”, listen, trust and respond more accurately to one's brain-body system. Vocal communication stimulates the growth of the entire CNS. The larynx is supported by the spinal column, which allows vocalizing to naturally produce vibrations that can soothe, organize and focus brain activity. Rich overtones can produce a strong self-affirming emotional response; the stimulation of live, unamplified sound makes the body-system more responsive to all sensory input. Additionally, the voice can be used as a healing instrument for the mind-body; an individual consciously vocalizing specific tones can bring healing and support to the body.

### BRIEF SUMMARY

The problem to be solved is to provide an improved apparatus and method for total brain development that pairs a bodily movement with an unassisted sound to achieve a greater benefit of cognitive development for the user. The solution is provided by presenting the user with one of three types of cues which instruct the user regarding a basic movement that is paired with an unassisted sound and enables the user to perform said basic movement and sound. These cues promote brain growth and development in specific regions of the brain and also build upon recall and improvisation skills in the user.

An “unassisted sound” shall mean an auditory noise that is user-generated that does not involve the use of any instrumentalities, devices, or components other than a user's own body. For example, an unassisted sound may include, speaking, singing, humming, clapping, or tapping against one's body. It would not include a user creating a noise by slapping a table or a noise requiring the use of another object. It additionally would not include a sound generated by an infant touching an electronic device, such as in Patent No. US20140045158A1. Furthermore, “unassisted sound” does not refer to any sound that the user merely hears or that is played for or by the user.

The purpose and objective of combining a bodily movement with an unassisted sound in specific ways in order to impact the strength and health of the entire brain is applicable to both the neurodevelopment stage of early development or for rehabilitative purposes at a later stage of development. Because the learned associations of the brain can carry on into adulthood, it is beneficial for users of any age to engage in the specific exercises to stimulate the various areas of the brain. Additionally, stimulating certain regions of the brain can trigger positive responses that are useful at any stage of development. For example, stimulating the vestibular region of the brain may result in increased attentiveness and focus, while stimulating the cortex may stimulate active thinking.

Stimulating the entire brain by performing movements and unassisted sounds can strengthen previously existing synaptic connections or rewire the brain to form new ones, depending on the state of development of the user. In early development, these stimulations are important to set the foundation for future learning and growth and to reinforce the reflexive wiring acquired in utero. Targeting specific areas of the brain for cognitive growth is particularly useful for rehabilitative purposes; brains in later stages of development may not need require total brain development reinforcement, but rather focused cognitive therapies tailored to certain areas of the brain that are underdeveloped or incorrectly wired. Cognitive therapies for precise regions of the brain may help to fix proper brain associations and reflexes.

In summary, the illustrated embodiments of the invention thus include an apparatus for cognitive development or rehabilitation comprising a cue that refers to a paired bodily movement and unassisted sound, wherein the cue enables a user to perform both the bodily movement and unassisted sound in sync to achieve increased cognitive stimulation and promote a specific cognitive health benefit in the user. The “user” of the apparatus and method shall refer to the one performing the particular movements and unassisted sounds in order to achieve cognitive growth. The “user” is the recipient of the therapy; “user” does not refer to the person presenting the cues as part of a therapeutic or educational regime.

There are three different types of cues: a first type of cue including a description of a bodily movement and accompanying unassisted sound to be performed; a second type of cue including a pictorial representation of a predetermined bodily movement and accompanying unassisted sound to be performed; and a third type of cue including a written description of a bodily movement and accompanying unassisted sound that prompts improvisation and expansion of the actions to be performed.

In one embodiment, the cues may be cards manipulated by a teacher and/or a user, audiovisual displays provided by a device or computer controlled by a teacher and/or user, or may be interactively generated by the user using an audio, visual or audiovisual device. The card is numbered according to which bodily movement and accompanying unassisted sound is referenced on the card itself, and the same number is used for each pairing among the three types of card. The numbers allow for a variation in the therapeutic method such that a specific region of brain development may be targeted by using specifically numbered cards that target a precise brain region for development, rather than using all of the cards for total brain development.

The illustrated embodiments of the invention also include a therapeutic method comprising the steps of presenting a first cue to a user that describes how a predetermined bodily movement and unassisted sound is to be performed by the user; and enabling the user to perform the predetermined bodily movement and unassisted sound.

The therapeutic method further includes the step of presenting a second cue indicative of the predetermined bodily movement and unassisted sound which the user is to perform. In one embodiment, this may be performed by presenting the user a pictorial representation of the movement and unassisted sound.

The therapeutic method further includes the step of presenting a third cue which prompts user to improvise on the predetermined bodily movement and unassisted sound which the user is to perform. After the user is instructed on how and what movement and sound to perform by use of the first cue, then the second cues need only be used. The third cues to induce improvisation can then be used alone or in combination with the first and/or second cues as desired.

In one embodiment the first cue prompts the user to connect a loud “OOUUMMM” vocalization with taking a deep breath that fills the lower belly in order to induce contentment and emotional and inner calm in the user. This could be called the “belly bugle” or breath cue.

In another embodiment the first cue prompts the user to perform a steady beat by drumming on the body in order to synchronize the body's natural rhythm and support the function of the brain stem, cerebellum and limbic system. This could be called the “body drum” or tactile cue.

In still another embodiment the first cue prompts the user to begin core, low vocalizations that progress into higher pitch contours while the user gradually extends limbs outward from a curved, inward position in order to soothe the central nervous system while supporting an energetic nervous system and charging the cortex for active thinking. This could be called the “silly siren” or core distal cue.

In one embodiment the instructional cue prompts the user to sustain a high-frequency “Zzz” sound while actively wiggling the pelvis, back and neck in order to strengthen the body for stationary activities and increase self-regulation, focus, attention and memory. This could be called the “ziggles” or head tail cue.

In another embodiment the first cue prompts the user to produce high pitched vowels while stabilizing the lower body and only moving the upper body in order to vibrate the skull and stimulate the cortex, resulting in improved alertness, oral expression and retention and manual dexterity resulting from the body movement. This could be called the “hooting owl” or upper body/voice cue.

In still another embodiment the first cue prompts the user to vocalize low “uh” noises while only moving the lower body in order to stimulate nerve endings in lower abdominals and thigh muscles to ground the user in his or her body, improve emotional stability, self-regulation and confidence, and also support gastro-intestinal function. This could be called the “bellowing giant” or lower body/voice cue.

In one embodiment the first cue prompts the user to move only the right side of the body while vocalizing a sequence or series of words, numbers, sounds, or phrases and focusing on listening to the vocalizations with the right ear in order to support auditory processing, language articulation, and working memory and provide the left brain with rich feedback that contributes to strong reading, writing, and oral communication skills. This could be called the “speak and rhythm” or right side/left brain cue.

In another embodiment the first cue prompts the user to move only the left side of the body by “painting” figures, pictures or shapes in space using only the left side while vocalizing sound effects or musical pitches in order to engage creative, exploratory based thinking and improve problem solving, communication of self-expression and emotional expressivity. This could be called the “shapes and sounds” or left side/right brain cue.

In still another embodiment the first cue prompts the user to position arms in front of body with a digit of the hand extended and to move one arm horizontally while pulsing the thumb and tracking digit move with eyes only and then vertically for each arm, followed by rubbing palms together and placing palms on eye sockets with eyes closed in order to synchronize eye muscles, improve focus and stamina, vestibular function, and fluidity and precision of ocular movement. This could be called the “track and pulse” or eye tracking and teaming cue.

In one embodiment the first cue prompts the user to move opposite quadrants of the body in all ways through space while singing or chanting in order to strengthen central nerve bundle connecting the right and left hemispheres and improve all parts of the brain, gross motor coordination, oral articulation, reading fluency and communication. This could be called the “song or rhyme” or opposite side/robust brain cue.

In another embodiment the first cue prompts the user to chant “boing” while bouncing up and down, vocalize a long “shsh” while swaying side to side”, vocalize a long “rrrr” sound while tipping front to back, and vocalize a long “weee” sound while spinning in alternate directions in order to improve balance, proprioceptive awareness, visual and auditory processing, and self-regulation. This could be called the “child at play” or vestibular cue.

In still another embodiment the first cue prompts the user to plant feet firmly on ground, place hands on belly, and breathe deeply and silently in order to support brain-body retention and integrate other activities and improve reflection, self-awareness and emotional stability. This could be called the “return to earth” or grounding cue.

While the apparatus and method has or will be described for the sake of grammatical fluidity with functional explanations, it is to be expressly understood that the claims, unless expressly formulated under 35 USC 112, are not to be construed as necessarily limited in any way by the construction of “means” or “steps” limitations, but are to be accorded the full scope of the meaning and equivalents of the definition provided by the claims under the judicial doctrine of equivalents, and in the case where the claims are expressly formulated under 35 USC 112 are to be accorded full statutory equivalents under 35 USC 112. The disclosure can be better visualized by turning now to the following drawings wherein like elements are referenced by like numerals.

### BRIEF DESCRIPTION OF THE DRAWINGS

FIG. 1 is a diagram that illustrates the front of a basic instructional type of card, according to one embodiment of the present invention.

FIG. 2 is a diagram that illustrates the back of a card which explains the benefits associated with a particular bodily movement and unassisted sound according to one embodiment of the present invention.

FIG. 3 is a diagram that illustrates the front of a second or prompting type of card, according to one embodiment of the present invention.

FIG. 4 is a diagram that illustrates the back of the second or prompting type of card, according to one embodiment of the present invention.

FIG. 5 is a diagram that illustrates the front of a third or improvisational type of card, according to one embodiment of the present invention.

FIG. 6 is a diagram that illustrates the front of a second or prompting type of card, according to one embodiment of the present invention.

FIG. 7 is a diagram that illustrates the front of a second or prompting type of card, according to one embodiment of the present invention.

FIG. 8 is a diagram that illustrates the front of a second or prompting type of card, according to one embodiment of the present invention.

FIG. 9 is a diagram that illustrates the front of a second or prompting type of card, according to one embodiment of the present invention.

FIG. 10 is a diagram that illustrates the front of a second or prompting type of card, according to one embodiment of the present invention.

FIG. 11 is a diagram that illustrates the front of a second or prompting type of card, according to one embodiment of the present invention.

FIG. 12 is a diagram that illustrates the front of a second or prompting type of card, according to one embodiment of the present invention.

FIG. 13 is a diagram that illustrates the front of a second or prompting type of card, according to one embodiment of the present invention.

FIG. 14 is a diagram that illustrates the front of a second or prompting type of card, according to one embodiment of the present invention.

FIG. 15 is a diagram that illustrates the front of a second or prompting type of card, according to one embodiment of the present invention.

FIG. 16 is a diagram that illustrates the front of a second or prompting type of card, according to one embodiment of the present invention.

FIG. 17 is a diagram that illustrates the front of a second or prompting type of card, according to one embodiment of the present invention.

FIG. 18 is a diagram that illustrates the front of a second or prompting type of card, according to one embodiment of the present invention.

FIG. 19 is a flowchart that shows the method of using the first type of cue, according to one embodiment of the present invention.

FIG. 20 is a flowchart that shows the method of using the second type of cue, according to one embodiment of the present invention.

FIG. 21 is a flowchart that shows the method of using the third type of cue, according to one embodiment of the present invention.

The disclosure and its various embodiments can now be better understood by turning to the following detailed description of the preferred embodiments which are presented as illustrated examples of the embodiments defined in the claims. It is expressly understood that the embodiments as defined by the claims may be broader than the illustrated embodiments described below.

### DETAILED DESCRIPTION OF THE PREFERRED EMBODIMENTS

Many alterations and modifications may be made by those having ordinary skill in the art without departing from the spirit and scope of the embodiments. Therefore, it must be understood that the illustrated embodiment has been set forth only for the purposes of example and that it should not be taken as limiting the embodiments as defined by the following embodiments and its various embodiments.

The preferred embodiment of this invention consists of three different sets of cards, each containing 12 different cards that serve various functions of stimulating cognitive growth. The three sets of cards are named: basic (instructional), picture (prompting), and exploration (improvisational). Each of the three sets of cards refer to the same series of bodily movements paired with unassisted sounds, but differ in how the information is presented to the user. Each pairing of a bodily movement and unassisted sound is provided a number that remains consistent throughout each of the different sets. The basic, picture, and exploration cards are color-coded so users can easily identify a specific set of cards.

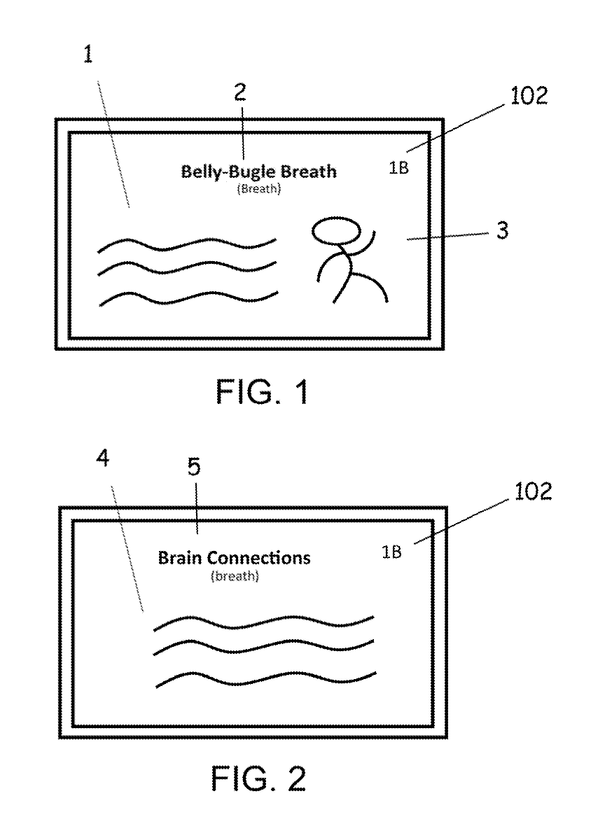

The first set of cards (“basic cards”) contain a written description of a predetermined bodily movement that is paired with a specific unassisted sound. The basic cards teach the user how to perform the specific action and explains the unassisted sound that is to accompany the action. FIG. 1 illustrates the front of a basic card which contains a heading 2 that displays the name of the specific bodily movement and sound pairing. It also contains a written description 1 and a pictorial representation 3 of the action and sound pairing the user is to perform. The front of the card displays a FIG. 102 consisting of a number and letter. The number identifies the movement and sound pairing that is to be performed; each pairing is designated a specific number that remains consistent throughout the different types of cards. The letter identifies the type of card. Basic cards are labelled with a “B”, picture cards with a “P”, and exploration cards with an “E”. FIG. 2 illustrates the back of a basic card, which shows the brain connections associated with the bodily movement and unassisted sound. The back contains a heading 5, a written description 4 of the areas of the brain that are targeted by the sequence of bodily movement and unassisted sound, and a FIG. 102 displaying the card number and type.

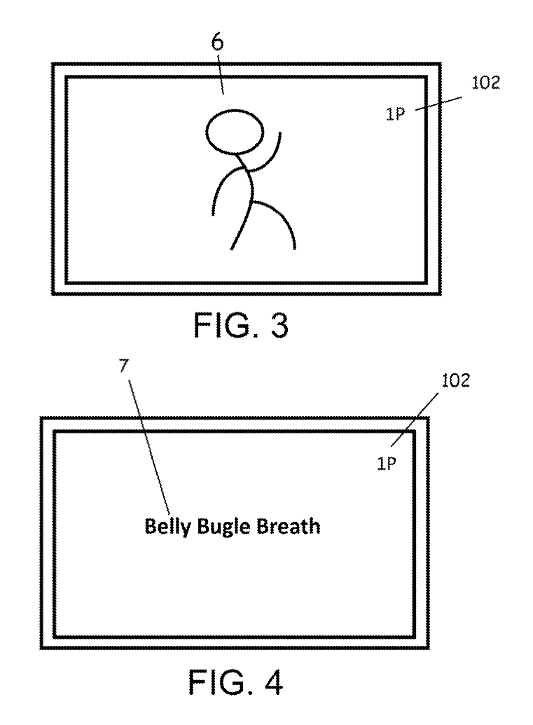

The second set of cards (“picture cards”) contain a pictorial representation of the predetermined bodily movement and unassisted sound. See FIG. 3 for reference. Instead of using a written description to teach the activity to the user, this type of card draws upon a user's recall abilities by prompting a user to perform the specific movement and sound through a minimalistic illustrative cue. The front of the card contains a graphic representation 6 of the action the user is to perform, along with a FIG. 102 that displays the card number and type. The back of the card contains the name of the action itself (see FIG. 4, which contains the name 7 and a FIG. 102 that identifies the card number and type). Picture cards are best utilized after a user has mastered the concepts presented in the basic cards and is able to perform the movement and sound with ease.

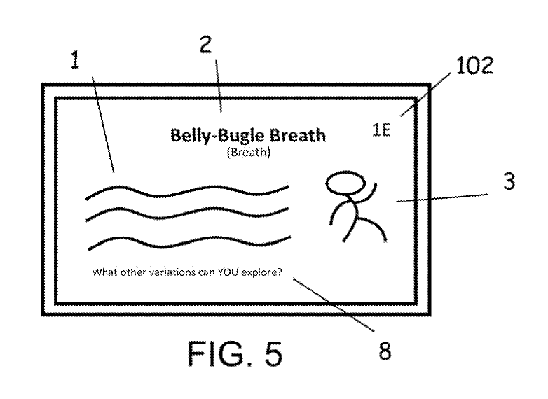

The third set of cards (“exploration cards”) are similar to the basic cards but prompt users to explore and expand the movements indicated on the card. The front of the card (see FIG. 5) provides a heading 2 with the name of the paired bodily movement and unassisted sound, and a written description 1 of the movement and associated unassisted sound=that includes a prompt 8 for the user to add variations to the movement and sound. The card additionally includes a pictorial representation 3 of the bodily movement and sound. The front of the card also includes a FIG. 102 identifies the card number and type. The back of an exploration card lists the brain connections that are developed by that particular card type (FIG. 2) and is the same as the back of the basic card type, containing a heading 5, a written description 4, and a FIG. 102 identifying the card number and type. Exploration cards allow a user to practice improvisation skills in addition to recall; the user will also receive the benefit of the neurodevelopment stimulated by the action and sounds prompted by the card itself.

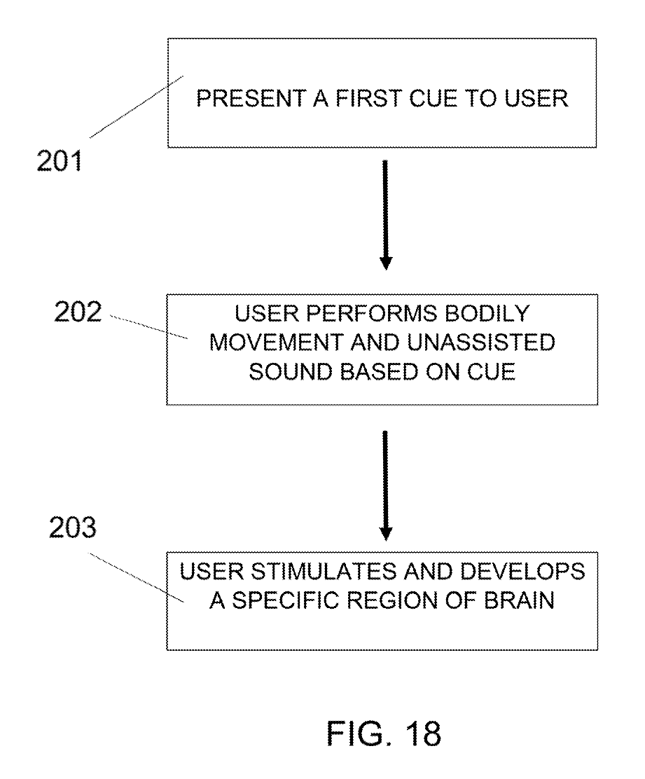

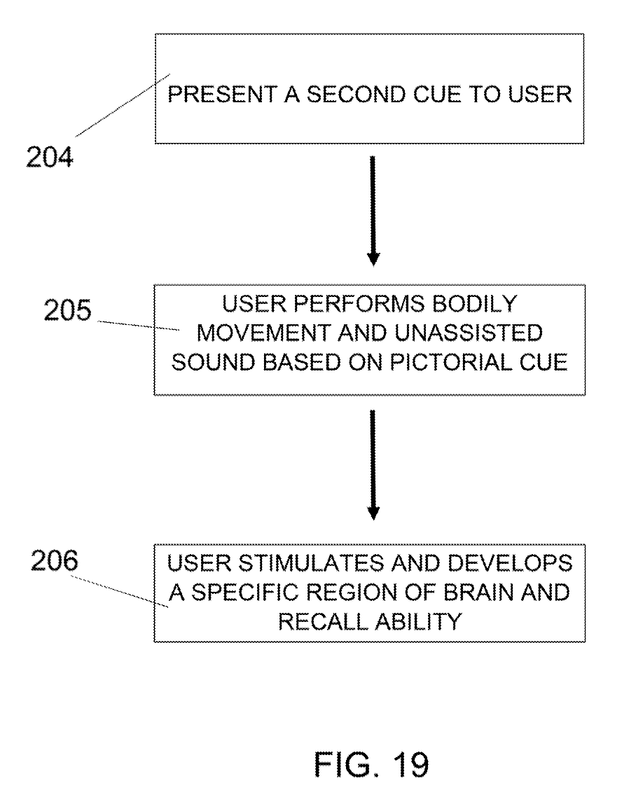

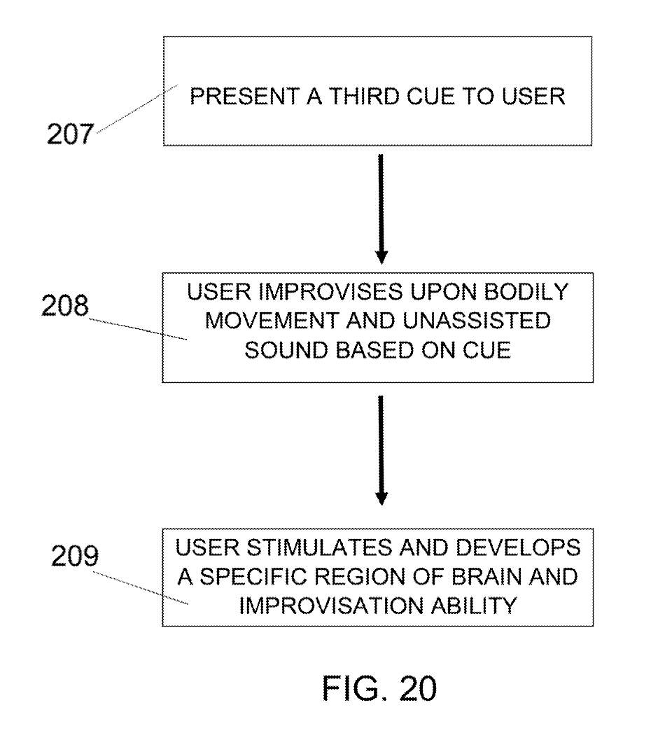

The illustrated embodiments of the invention also include a therapeutic method comprising the steps of presenting a first cue to a user that describes how a predetermined bodily movement and unassisted sound is to be performed by the user; and enabling the user to perform the predetermined bodily movement and sound. See FIG. 18 for reference. The therapeutic method further includes the step of presenting a second cue indicative of the predetermined bodily movement and unassisted sound which the user is to perform. See FIG. 19 for reference. The therapeutic method further includes the step of presenting a third cue which prompts user to improvise on the predetermined bodily movement and unassisted sound which the user is to perform. See FIG. 20 for reference.

After the user is instructed on how and what movement and sound to perform by use of the first cue, then the second cues need only be used. The third cues to induce improvisation can then be used alone or in combination with the first and/or third cues as desired.

In the preferred embodiment, the cue being presented to the user is in the form of a card. An instructor presents a first card to the user 201 and assists the user in performing the movement and sound 202, possibly mimicking the movement and sound by his or herself for the user. The user will then perform the described action to achieve neural stimulation. 203 Cards are presented in a specific order which will target a predetermined area for neurodevelopment in that region. For total brain development, all of the cards (1-12) will be used. There are various combinations of cards that will target certain areas of the brain, such as self-regulation, memorization, problem solving, and focus. An instructor may wish to target a user's creativity and problem solving and would present the user with cards 2, 4-8, and 10-11, for example, rather than the entire set of cards. Once users are familiar with the basic cards (see FIG. 18), the user will move on to picture cards (see FIG. 19); once the user has mastered his or her recall abilities through the picture cards, the user will move on to exploration cards (see FIG. 20).

In one embodiment, after the user is familiar with the basic cues, an instructor will present a second cue to the user 204 and the user performs an action and sound based on a pictorial cue that is indicative of a bodily movement and unassisted sound pairing that is to be performed 205. By performing the action and sound, the user stimulates a specific area of the brain and additionally exercises recall abilities 206.

In one embodiment, after the user is familiar with the pictorial cue, an instructor will present a third cue to the user 207 and the user improvises upon a bodily movement and unassisted sound pairing based upon the cue 208. By performing the action and sound, the user stimulates a specific region of the brain and additionally exercises improvisational skills 209.

In another embodiment, the cue is presented through audiovisual displays, such as through an instructional recording displayed on a television, computer, phone, tablet screen, or other device.

In another embodiment, the cue is presented through an audio device, such as through a recording or someone speaking directly to the user.

In yet another embodiment, the cue is interactively generated by the user using an audio, visual, or audiovisual device.

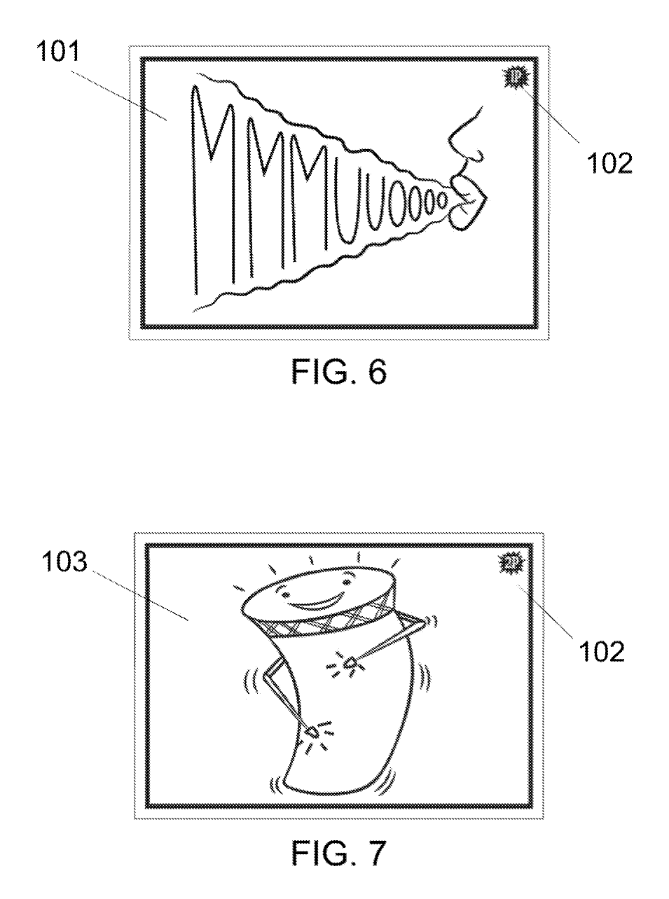

In one embodiment the first cue prompts the user to take a deep breath that fills the lower belly and connect a loud “OOUUMMM” vocalization with while exhaling in order to induce contentment and emotional and inner calm in the user. This could be called the “belly bugle” or breath cue. Inhaling from the belly and exhaling slowly while making an “OOOUUU” sound, followed by bringing the lips together with and “MMM” sound supports the user's ability to focus and extend his or her breath. This improves focus and relaxed attention which is an optimal state for learning. This cue deepens the user's “belly breath” and provides a richer supply of oxygen and energy to the brain. The extended vocalized breath stabilizes the user's brainwave-state, inducing relaxation and inner calm. See FIG. 6 for reference of a picture card showing an embodiment of a pictorial display of the “belly bugle” cue 101 and a figure (1P) for the card number and type 102.

In another embodiment the first cue prompts the user to perform a steady beat by drumming on the body in order to synchronize the body's natural rhythm and support the function of the brain stem, cerebellum and limbic system. This could be called the “body drum” or tactile cue. The user may tap, pat, or clap across the body while using a firm touch to emphasize a strong “pulse”. The user drums on various parts of the body, such as the torso, legs, back, head, etc. This movement and sound generated by the user establishes synchronization of the body-brain; steady beat keeping against the body grounds the autonomic nervous system and supports healthy adrenal function. Additionally, the use of the hands and fingers add an abundance of neurological feedback to the brain and central nervous system. This embodiment may be useful as a classroom management tool because it establishes a common pulse and tempo to a group. See FIG. 7 for reference of a picture card showing an embodiment of a pictorial display of the “body drum” cue 103 and a figure (2P) for the card number and type 102.

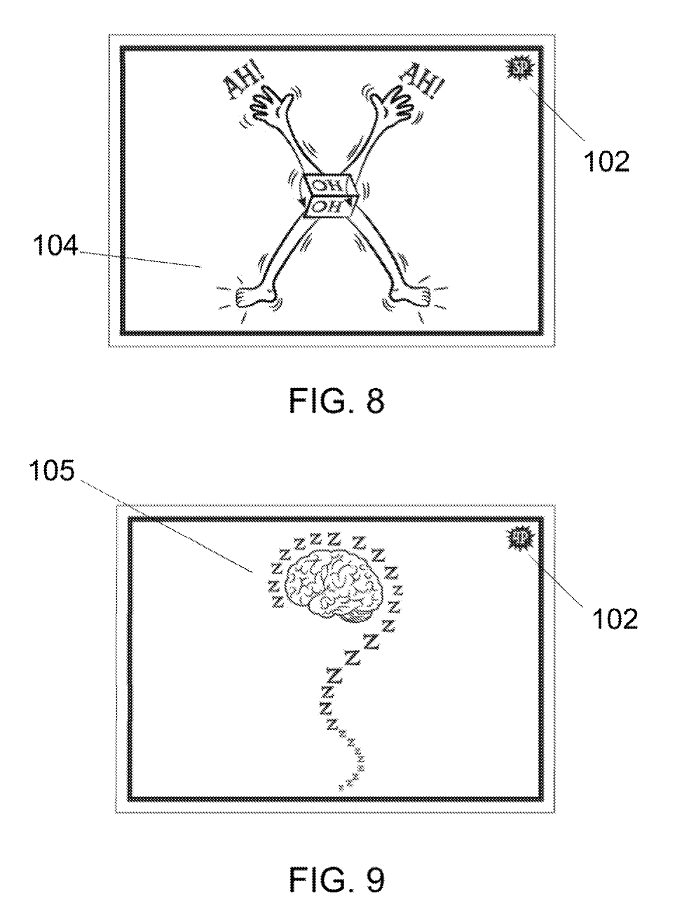

In still another embodiment the first cue prompts the user to begin core, low vocalizations that progress into higher pitch contours while the user gradually extends limbs outward from a curved, inward position in order to soothe the central nervous system while supporting an energetic nervous system and charging the cortex for active thinking. This could be called the “silly siren” or core-distal cue. The user starts by curving the body in towards the belly button (core) and vocalizes a low “OH” sound. The user gradually straightens and extends all four limbs (distal) while rising in vocal pitch from the “OH” to a high pitched “AH” sound. The user then reverses the process. The low vocalization soothes and de-stresses the central nervous system. The ascending/descending vocalism stimulates key energy points along the spine, creating a “vibrational massage”. The synchronized kinesthetic and vocal ascending/descending supports an energetic nervous system while the upper vocal range charges the cortex for active thinking. Additionally, a strong core supports stationary activities that also require focused attention (such as sitting at a desk). See FIG. 8 for reference of a picture card showing an embodiment of a pictorial display of the “silly siren” cue 106 and a figure (3P) for the card number and type 102.

In one embodiment the instructional cue prompts the user to sustain a high-frequency “ZZZ” sound while actively wiggling the pelvis, back and neck and placing one hand on the head and the other at the lower back in order to strengthen the body for stationary activities and increase self-regulation, focus, attention and memory. This could be called the “ziggle” or head-tail cue. The high frequency overtones of the “ZZZ” energize the central nervous system, awakening and invigorating a “lively spine”. The user strengthens the pelvis, back and neck to support stationary activities. The act of wiggling together with the high-overtone “ZZZ” initiates a free flow of energy throughout the body that results in the brain's ability to obtain a state of “relaxed focus”, which is ideal for learning and memory. The user may also improve his or her self-regulation, focus, attention, learning and memory. See FIG. 9 for reference of a picture card showing an embodiment of a pictorial display of the “ziggle” cue 107 and a figure (4P) for the card number and type 102.

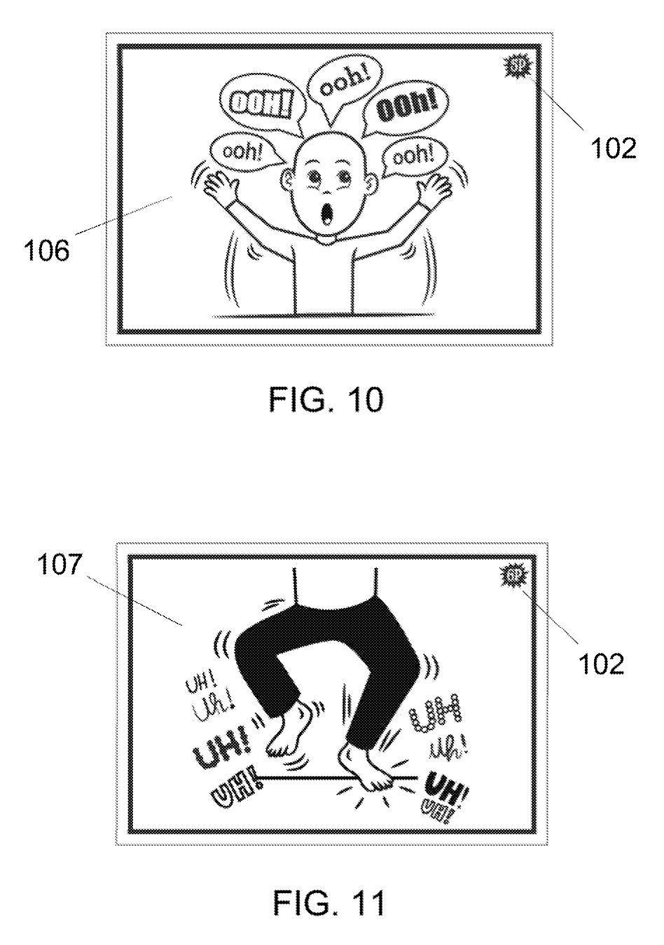

In another embodiment the first cue prompts the user to produce high pitched vowels while stabilizing the lower body and only moving the upper body in order to vibrate the skull and stimulate the cortex, resulting in improved alertness, oral expression and retention and manual dexterity resulting from the body movement. This could be called the “hooting owl” or upper body/voice cue. The user may choose swing, stretch, and twist ONLY the upper body while vocalizing vowel sounds such as “OOH” or “EEE”. The high pitched frequency of the “OOH” (and other higher pitched vowels) vibrates the skull and energizes the brain. The voice the most potent inducer of these higher frequencies for neural stimulation, such as alertness, oral expression, and retention. Higher frequency vocalism is also known to support and enhance immune function. Additionally, the accompanying upper body movements may improve manual dexterity (fine and gross) and coordination. See FIG. 10 for reference of a picture card showing an embodiment of a pictorial display of the “hooting owl” cue 109 and a figure (5P) for the card number and type 102.

In still another embodiment the first cue prompts the user to vocalize low “UH” noises, varying in pitch, while only moving the lower body in order to stimulate nerve endings in lower abdominals and thigh muscles to ground the user in his or her body, improve emotional stability, self-regulation and confidence, and also support gastro-intestinal function. This could be called the “bellowing giant” or lower body/voice cue. The low pitched frequency of the “UH” grounds the lower abdomen, thighs and feet, allowing the user to be more present in his or her body. See FIG. 11 for reference of a picture card showing an embodiment of a pictorial display of the “bellowing giant” cue 111 and a figure (6P) for the card number and type 102.

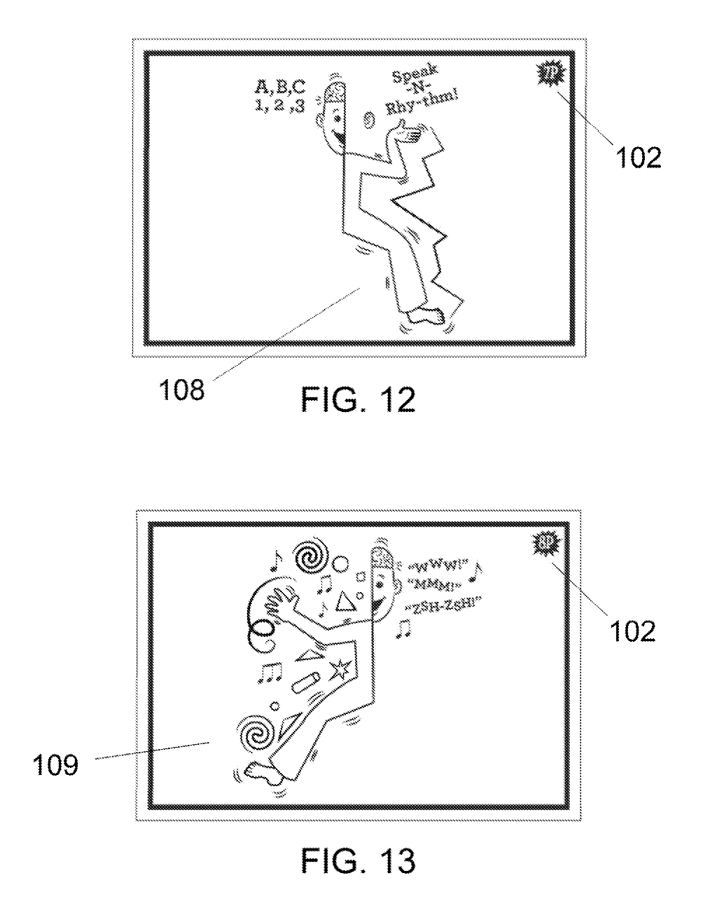

In one embodiment the first cue prompts the user to move only the right side of the body while vocalizing a sequence or series of words, numbers, sounds, or phrases and focusing on listening to the vocalizations with the right ear in order to support auditory processing, language articulation, and working memory and provide the left brain with rich feedback that contributes to strong reading, writing, and oral communication skills. This could be called the “speak and rhythm” or right side/left brain cue. The user is to move by keeping a steady rhythm with only the right side while speaking a sequence or series of phrases, words, or numbers. The movement and vocalization supports the organizational and sequential aspects of language learning and improves language articulation, working memory, and auditory processing. Focused listening with the right ear is beneficial to language-based learning because the right ear/auditory pathway has more numerous and more direct neural connections to the language centers of the left brain. By using the right ear to focus on the sounds made by the user, the left brain is provided with rich feedback that contributes to strong reading, writing and oral communication skills. Additionally, the dissection of spoken words with the beat subdivisions (moved or pulsed while speak the key words) supports auditory processing and memory. See FIG. 12 for reference of a picture card showing an embodiment of a pictorial display of the “speak and rhythm” cue 113 and a figure (7P) for the card number and type 102.

In another embodiment the first cue prompts the user to move only the left side of the body by “painting” figures, pictures or shapes in space using only the left side while vocalizing sound effects or musical pitches in order to engage creative, exploratory based thinking and improve problem solving, communication of self-expression and emotional expressivity. This could be called the “shapes and sounds” or left side/right brain cue. The user additionally can engage the face in expressing and emoting while drawing the figures in the air to improve emotional expressivity. Spatial exploration (both in the vocal pitch and physical movement) using improvised vocal sound effects engages the exploratory-based thinking associated generally with the right brain. This type of neural activity is useful for meaningful learning, intuitive thinking, problem solving, and creativity. The user may improve reading fluency, divergent thinking, and oral communication. See FIG. 13 for reference of a picture card showing an embodiment of a pictorial display of the “shapes and sounds” cue 115 and a figure (8P) for the card number and type 102.

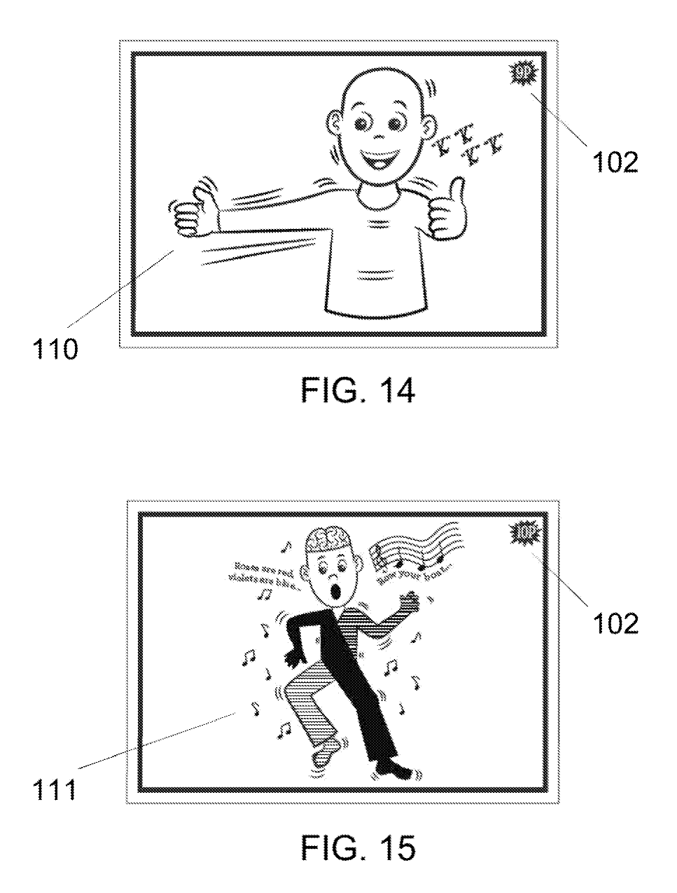

In still another embodiment the first cue prompts the user to position both arms in front of body with thumbs extended and to move right arm horizontally while pulsing the thumb and tracking thumb movement with eyes only and then repeat process vertically, while vocalizing a percussive consonant or digraph (a pair of letters expressing one sound, for example “sh”, “ch”, “ph”, etc.). The user switches to the left arm to perform the same movements. The move is concluded by rubbing palms together until warm and placing palms on eye sockets with eyes closed in order to synchronize eye muscles, improve focus and stamina, vestibular function, and fluidity and precision of ocular movement. This could be called the “track and pulse” or eye tracking and teaming cue. By incorporating a percussive consonant while pulsing the thumb with eye movement, the user refines the synchronization of the eye's ability to track and team. This movement provides a stress break from daily two-dimensional eye work. Healthy teaming and tracking with a vocal pulse strengthens the vestibular system. See FIG. 14 for reference of a picture card showing an embodiment of a pictorial display of the “track and pulse” cue 117 and a figure (9P) for the card number and type 102.

In one embodiment the first cue prompts the user to move opposite quadrants of the body in all ways through space while singing or chanting in order to strengthen central nerve bundles (corpus callosum) connecting the right and left hemispheres and can stimulate all parts of the brain. This could be called the “song or rhyme” or opposite side/robust brain cue. Connecting chanted or sung words to a simple rhyme or melody while moving opposite body sides engages the robust brain. The robust brain includes all parts of the brain (cortex, limbic system, cerebellum and pons). This movement and vocalization also strengthens the corpus callosum, which is responsible for the balance of communication between both sides of the cerebral cortex. The pulse and rhythm within the phrasing integrates the physical coordination and refinement of movement associated with the cerebellum and basal ganglia. It may also improve gross motor coordination, oral articulation, reading fluency and communication, motivation. Additionally, this movement and vocalization may also be used to improve social connectivity when performed with others; when moving and singing is performed in a group setting, the “bonding” neurochemical oxytocin is secreted, which supports a sense of connectivity and community. See FIG. 15 for reference of a picture card showing an embodiment of a pictorial display of the “song or rhyme” cue 119 and a figure (10P) for the card number and type 102.

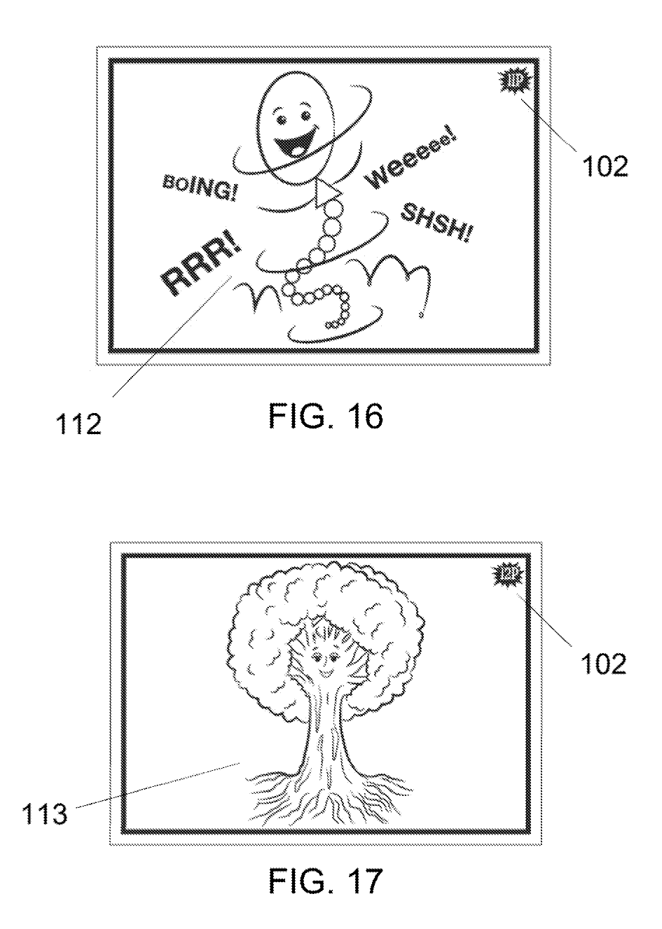

In another embodiment the first cue prompts the user to chant “boing” while bouncing up and down, vocalize a long “shsh” while swaying side to side”, vocalize a long “rrrr” sound while tipping front to back, and vocalize a long “weee” sound while spinning in alternate directions in order to improve balance, proprioceptive awareness, visual and auditory processing, and self-regulation. This could be called the “child at play” or vestibular cue. The vestibular system is a pervasive neurological system that acts as a gateway to all other parts of the brain. It is the first system to fully develop in utero. The vestibular system is responsible for balance, movement, memory, energy state and regulation, sleep/wake cycle, and food satiation; the bodily movements of this cue stimulates vestibular movement. A strong vestibular system is essential for strengthening all parts of the brain and body. The vocal movement couples with the vestibular movement provides novelty to the user and inspires the imagination. See FIG. 16 for reference of a picture card showing an embodiment of a pictorial display of the “child at play” cue 121 and a figure (11P) for the card number and type 102.

In still another embodiment the first cue prompts the user to plant feet firmly on ground, place hands on belly, and breathe deeply and silently in order to support brain-body retention, intuitive integration of other activities and improve reflection, self-awareness and emotional stability. This could be called the “return to earth” or grounding cue. This cue acts as a final cool down to allow the brain-body to absorb and process the rich flow of input provided by the other cues. It improves the brain-body's ability to intuitively integrate the benefits of the previously stated cues into other daily activities. Quietly listening to the natural cadence of the inhale/exhale deepens the breath and soothes vital organs, creating an instant state of rest and relaxation. See FIG. 17 for reference of a picture card showing an embodiment of a pictorial display of the “return to earth” cue 123 and a figure (12P) for the card number and type 102.

The illustrated embodiment has been set forth only for the purposes of example and that it should not be taken as limiting the embodiments as defined by the following claims. For example, notwithstanding the fact that the elements of a claim are set forth below in a certain combination, it must be expressly understood that the embodiments includes other combinations of fewer, more or different elements, which are disclosed in above even when not initially claimed in such combinations. A teaching that two elements are combined in a claimed combination is further to be understood as also allowing for a claimed combination in which the two elements are not combined with each other, but may be used alone or combined in other combinations. The excision of any disclosed element of the embodiments is explicitly contemplated as within the scope of the embodiments.

The words used in this specification to describe the various embodiments are to be understood not only in the sense of their commonly defined meanings, but to include by special definition in this specification structure, material or acts beyond the scope of the commonly defined meanings. Thus if an element can be understood in the context of this specification as including more than one meaning, then its use in a claim must be understood as being generic to all possible meanings supported by the specification and by the word itself.

The definitions of the words or elements of the following claims are, therefore, defined in this specification to include not only the combination of elements which are literally set forth, but all equivalent structure, material or acts for performing substantially the same function in substantially the same way to obtain substantially the same result. In this sense it is therefore contemplated that an equivalent substitution of two or more elements may be made for any one of the elements in the claims below or that a single element may be substituted for two or more elements in a claim. Although elements may be described above as acting in certain combinations and even initially claimed as such, it is to be expressly understood that one or more elements from a claimed combination can in some cases be excised from the combination and that the claimed combination may be directed to a subcombination or variation of a subcombination.

Insubstantial changes from the claimed subject matter as viewed by a person with ordinary skill in the art, now known or later devised, are expressly contemplated as being equivalently within the scope of the claims. Therefore, obvious substitutions now or later known to one with ordinary skill in the art are defined to be within the scope of the defined elements.

The claims are thus to be understood to include what is specifically illustrated and described above, what is conceptionally equivalent, what can be obviously substituted and also what essentially incorporates the essential idea of the embodiments.

1. An apparatus for brain development or rehabilitation comprising:
a cue that refers to a paired bodily movement and unassisted sound;
wherein the cue enables a user to perform both the bodily movement and unassisted sound in sync to achieve increased brain stimulation.

2. The apparatus of claim 1, wherein: the cue refers to a predetermined bodily movement and unassisted sound that is paired to promote at least one neurodevelopmental benefit in the user.

3. The apparatus of claim 1, wherein: the cue is physical, visual, auditory or a combination of at least two of the three types.

4. The apparatus of claim 1, wherein: the cue is a set of a plurality of cards each with a face and a back.

5. The apparatus of claim 4, wherein: the set of cards includes three different types of cards.

6. The apparatus of claim 4, wherein: the first type of card having a front and a back side; the front side of the card includes a written description of a predetermined bodily movement and accompanying unassisted sound and the back side of the card includes a description of a neurodevelopmental benefit associated with the bodily movement and unassisted sound.

7. The apparatus of claim 4, wherein: the second type of card having a front and a back side; the front side includes a pictorial representation of a predetermined bodily movement and accompanying unassisted sound on one side of the card; the back side includes a name assigned to the paired bodily movement and unassisted sound.

8. The apparatus of claim 4, wherein: The third type of card having a front and a back side; The front side includes a written description of a predetermined bodily movement and accompanying unassisted sound that prompts improvisation and expansion of the bodily movement and sound on one side of the card; and The back side includes a description of the neurodevelopmental benefits associated with the bodily movement and unassisted sound.

9. The apparatus of claim 3, wherein the card for a bodily movement and accompanying unassisted sound is numbered,
whereby a specific region of brain development may be targeted by using a smaller subset of the specifically numbered cards to target a precise brain region for development.

010. A method for brain development or rehabilitation comprising:
presenting a first cue to a user that describes how a predetermined bodily movement and unassisted sound is to be performed by the user; and
enabling the user to perform the predetermined bodily movement and unassisted sound.

11. The method of claim 10 further comprising presenting a second cue indicative of the predetermined bodily movement and unassisted sound which the user is to perform.

12. The method of claim 10 further comprising presenting a third cue which prompts user to improvise on the predetermined bodily movement and unassisted sound which the user is to perform.

13. The method of claim 10 wherein the cue is presented to a user through an audiovisual display.

14. The method of claim 10 wherein the cue is presented to a user through an auditory device.

15. The method of claim 10 wherein the cue is presented to a user through a computing device.

16. The method of claim 10 wherein the cue is presented to a user by a physical object.

17. The method of claim 10 wherein in the cue is presented to a user as a card.

18. The method of claim 10 wherein the first cue prompts the user to connect a loud “OOUUMMM” vocalization with taking a deep breath that fills a lower belly in order to induce contentment and emotional and inner calm in the user.

19. The method of claim 10 wherein the first cue prompts the user to perform a steady beat by drumming on a body in order to synchronize the body's natural rhythm and support the function of a brain stem, cerebellum and limbic system.

20. The method of claim 10 wherein the first cue prompts the user to begin core, low vocalizations that progress into higher pitch contours while the user gradually extends limbs outward from a curved, inward position in order to soothe a central nervous system while supporting an energetic nervous system and charging a cortex for active thinking.

21. The method of claim 10 wherein the instructional cue prompts the user to sustain a high-frequency “Zzz” vocalization while actively wiggling a pelvis, a back and a neck in order to strengthen a body for stationary activities and increase self-regulation, focus, attention and memory.

22. The method of claim 10 wherein the first cue prompts the user to produce high pitched vowels while stabilizing a lower body and only moving an upper body in order to vibrate a skull and stimulate a cortex, resulting in improved alertness, oral expression and retention and manual dexterity resulting from the body movement.

23. The method of claim 10 wherein the first cue prompts the user to vocalize low “uh” noises while only moving lower body in order to stimulate nerve endings in lower abdominal and thigh muscles to ground the user in his or her body, improve emotional stability, self-regulation and confidence, and also support gastro-intestinal function.

24. The method of claim 10 wherein the first cue prompts the user to move only the right side of the body while vocalizing a sequence or series of words, numbers, vocalizations, or phrases and focusing on listening to the vocalizations with a right ear in order to support auditory processing, language articulation, and working memory and provide a left brain with rich feedback that contributes to strong reading, writing, and oral communication skills.

25. The method of claim 10 wherein the first cue prompts the user to move only a left side of the body by “painting” figures, pictures or shapes in space using only the left side while vocalizing sound effects or musical pitches in order to engage creative, exploratory based thinking and improve problem solving, communication of self-expression and emotional expressivity.

26. The method of claim 10 wherein the first cue prompts the user to position two arms in front of a body with a digit of a hand extended and to move one arm horizontally while pulsing a thumb and tracking digit movement with eyes only and then vertically for each arm, followed by rubbing two palms together and placing palms on two eye sockets with eyes closed in order to synchronize eye muscles, improve focus and stamina, vestibular function, and fluidity and precision of ocular movement.

27. The method of claim 10 wherein the first cue prompts the user to move opposite quadrants of a body in all ways through space while Singing or chanting in order to strengthen a central nerve bundle connecting a right and left hemisphere of a brain and to improve all parts of the brain, gross motor coordination, oral articulation, reading fluency and communication.

28. The method of claim 10 wherein the first cue prompts the user to chant “boing” while bouncing up and down, vocalize a long “shsh” while swaying side to side”, vocalize a long “rrrr” vocalization while tipping front to back, and vocalize a long “weee” vocalization while spinning in alternate directions in order to improve balance, proprioceptive awareness, visual and auditory processing, and self-regulation.

29. The method of claim 10 wherein the first cue prompts the user to plant two feet firmly on ground, place hands on a belly, and breathe deeply and silently in order to support brain-body retention and integrate other activities and improve reflection, self-awareness and emotional stability.
